(19) United States
(12) Patent Application Publication
(10) Pub. No.: US 2011/0117265 A1
(43) Pub. Date: May 19, 2011

(54) SLOWLY DIGESTIBLE STARCH PRODUCT

(75) Inventors: Rolf Müller, Zurich (CH); Federico Innerebner, Zurich (CH)

(73) Assignee: INNOGEL AG, Huenenberg (CH)

(21) Appl. No.: 12/944,465

(22) Filed: Nov. 11, 2010

Related U.S. Application Data
(63) Continuation of application No. 10/583,781, filed on Aug. 28, 2006, now abandoned.

(30) Foreign Application Priority Data
Dec. 18, 2003 (DE) 103 59 918.5

(51) Int. Cl. A23L 1/0522; C08B 30/12

(52) U.S. Cl. 426/661; 127/32

(57) ABSTRACT

The invention relates to a starch product in the form of a foodstuff ingredient and to a foodstuff per se whose hydrolysis speed during digestion can be set to low and especially almost constant in that the starch is obtained as a partially crystalline network with a low degree of swelling by means of targeted conditioning, starting from an at least partly amorphous state.

### CROSS REFERENCE TO RELATED APPLICATIONS

This application is a continuation of U.S. patent application Ser. No. 10/583,781, filed Aug. 28, 2006, which is the U.S. national stage designation of International Application No. PCT/CH04/00743 filed Dec. 17, 2004, which claims priority to DE 103 59 918.5, filed on Dec. 18, 2003, the entire contents of which are expressly incorporated herein by reference.

### BACKGROUND

The invention relates to a starch product in the form of a food ingredient and a food per se, the hydrolysis rate of which can be set to low values during digestion, and in particular can also be held nearly constant, by obtaining the starch proceeding from an at least partially amorphous state via specific conditioning as a partially crystalline network with a low swelling capacity.

During the manufacture of starch-containing foods, the starch is in most instances prepared to a point where it is digested extraordinarily quickly and converted into glucose in the process. This leads to a rapid rise in the blood sugar level (oversugar) followed soon thereafter by too great a drop in the blood sugar level (undersugar). Such foods have a high glycemic index (GI). A large number of recent studies indicate that foods with a high GI represent an important cause of diabetes, obesity and cardiovascular diseases. The WHO believes that specifying GI values on food packaging is a tool aiding in the pragmatic prevention of the mentioned illnesses. Therefore, there is a demand for starch-containing foods that have a reduced GI, i.e., are digested slowly. In this context, the ideal scenario revolves around a food for which hydrolysis is constant over time, wherein precisely the amount of glucose is released per unit of time that is consumed through metabolism. This type of food would be extremely desirable for diabetics in particular. Uncooked, i.e., native cornstarch, is currently used as the best solution for diabetics (WO 95/24906), and is digested relatively slowly. However, the consumption of native cornstarch in the form of aqueous slurries is unattractive on the one hand, and glucose can only be released at a constant rate over time on a limited basis on the other. U.S. Pat. No. 6,815,433 proposes an improvement in which native cornstarch is granulated into agglomerates using binders in order to further reduce the hydrolysis rate and keep it as constant as possible. One disadvantage to solutions based on native cornstarch is its limited thermal stability.

Other forms of slowly digestible starches include the resistant starches (e.g., resistant starches sold under one or more of the trademarks HIGHMAIZE, NOVELOSE, ACTISTAR, AND CRYSTALEAN). These starches have a high crystalline percentage, and are about 50% digestible in the small intestine. The remainder is fermented in the large intestine. The percentage digestible in the small intestine is largely digested very fast, so that resistant starches only make sense on a limited basis as a food additive for reducing the GI.

Other slowly digestible starches were described in WO 2004/066955 A2. These starches were obtained by gelatinizing a suspension of roughly 5% starch in water, and treating it with alpha amylase. The starch is then precipitated, during which a high crystalline percentage of it can be obtained. According to the disclosure, these starches have a digestive behavior lying between resistant starches and untreated, native starch.

Other slowly digestible starches are described in US 2003/0219520 A1 and US 2003/0215562 A1. Starches with a low amylose content or higher amylose content are here also gelatinized and branched to at least 90% at water contents exceeding 70% with branching enzymes (isoamylase, pullulanase). The starches are then precipitated and obtained with a high crystalline percentage, which lowers the digestion rate. The digestive behavior of these starches also lies between resistant starches and untreated, native starches.

The disadvantage to the solutions described in the cited patent applications involves the expensive and cumbersome multi-stage processes (gelatinizing, enzyme reaction, wherein over 10 hours are required for debranching, precipitation, centrifuging, cleaning, spray drying). In addition, the high crystallinity of the precipitation products gives them a digestive behavior similar to that of resistant starch, even if an overall larger percentage can be digested in the small intestine. A percentage of 50% is digested very quickly, similarly to white bread, which has a very high GI, and only about 20-30% is slowly digested. The rest is fermented in the large intestine. Since these solutions should be used as a food additive, only a portion of the starch can hence be substituted, and the achievable reduction in the GI is limited, even if high percentages are used.

### SUMMARY OF THE INVENTION

Therefore, the object of this invention is to provide a slowly digestible starch product using a simple method, wherein a wide range of hydrolysis characteristics can be achieved, in particular low hydrolysis rates and hydrolysis rates that are constant over as long a period as possible, wherein the thermal stability is sufficient for the thermal load in aqueous media during food preparation.

Additional features and advantages are described herein, and will be apparent from the following Detailed Description and the figures.

### BRIEF DESCRIPTION OF THE DRAWINGS

FIG. 1 shows hydrolysis curves for slowly digestible cornstarch products;

FIG. 2 shows hydrolysis curves for slowly digestible potato starch products;

FIG. 3 shows hydrolysis curves for slowly digestible pea starch products;

FIG. 4 shows influence of particle size on hydrolysis curves for slowly digestible pea and potato starch products; and

FIG. 5 shows hydrolysis curves for slowly digestible high-amylose content cornstarch products.

### DETAILED DESCRIPTION

The invention relates to a homogeneous, slowly digestible starch product, the hydrolysis rate of which can be set within broad limits using measures relating to recipe and method. In particular, it was surprisingly found that the starch product can be obtained with a low and, if necessary, constant hydrolysis rate, thereby enabling a prolonged, constant release of glucose. This makes it possible to favorably influence the blood sugar level, avoid oversugar and undersugar, and provide a long-lasting supply of energy in the form of glucose.

These advantageous properties of the starch product are obtained by at least partially gelatinizing or at least partially plasticizing the starch product in a first step. In the gelatinizing process, the partially crystalline structure of the starch grain is here transformed into an amorphous structure, wherein the grain is retained as an entity, while the grain also disappears in the plasticizing process. This is followed by conditioning, which is accompanied by recrystallization and the formation of a network or gel. A partially crystalline structure is here generated again, but it can be set in terms of the relevant parameters and has a higher thermal stability by comparison to the partially crystalline structure of native starch. It was here discovered that the level of amylase inhibition, and hence the level of hydrolysis rate reduction, increases with the scope of network formation, i.e., with rising network density. It was found that particularly advantageous structures were obtained using short chain amylose (SCA), wherein the formation rate of these structures can also be massively accelerated. The formed network imparts a limited swelling capacity to the starch product, restricting the entry of the amylases to be hydrated in the process of digestion. This results in a massively reduced digestion rate by comparison to the amorphous state, which yields a very rapid hydrolysis. The crystallites forming the linking points in the network are slowly digestible to indigestible. The indigestible portion in the small intestine is here present as resistant starch (RS). The digestible portion of crystallites and the amorphous phase with restricted swelling capacity are present as advantageous, slowly digestible starch comprising the bulk of the starch product. The ratio of slowly digestible starch to RS can be set using the network parameters, wherein in particular a very high percentage of slowly digestible starch can be obtained at a low percentage of RS, and the starch product can be obtained without a percentage of rapidly digestible starch. Therefore, any hydrolysis rates can be set overall between the very rapid and disadvantageous hydrolysis of amorphous starch encountered for most prepared starch products and those with a minimal hydrolysis rate.

The difference relative to WO 2004/066955 A2, US 2003/0219520 A1 and US 2003/0215562 A1 is primarily that the hydrolysis characteristics are set via the parameters of the network with a limited swelling capacity, for which a slight crystalline percentage is present in the form of the crystallites linking the network (roughly 1-50%), while the crystallites (roughly 40-70%) are mainly not interlinked after precipitation in prior art, and the characteristics of hydrolysis are determined by the varying perfection level of the crystallites (slowly digestible portion) and a percentage of freely accessible amorphous starch (rapidly digestible portion).

For example, the starch product can be present as a powder, and be used in this form as a food additive to reduce the overall hydrolysis rate or glycemic index (prevent oversugar) and ensure a lasting glucose supply (prevent undersugar). On the other hand, the starch product can also be ingested in tablet form, or consumed as a food per se, e.g., as a snack.

Basic Starch

The slowly digestible starch product can be manufactured proceeding from any starch (basic starch) or mixtures of starches, e.g., corn, wheat, potato, tapioca, rice, sago, pea starch, etc. Starches here include both starches in the narrower sense, along with flours and semolina. The starch can be changed chemically, enzymatically, physically or genetically. The amylose content of the starch can measure from 0 (waxy starches) up to nearly 100% (high amylose starches). Starches with good crystallization properties are preferred. These include starches in which the amylopectin A side chain has a chain length >10, preferably >12, most preferably >14, and/or starches in which the amylose content is >20, preferably >30, most preferably >50, and/or starches that were modified to obtain improved crystallization properties, such as starches hydrolyzed with acid and/or enzymatically, like thin boiling starches or partially debranched starches. The starches can be used in a non-gelatinized state, partially to completely gelatinized or partially to completely plasticized.

Short-Chained Amylose (SCA)

It is advantageous to additionally use short chain amylose (SCA) with a polymerization level of <300, preferably <100, more preferably <70, most preferably <50. For example, SCA can be obtained from amylose by using amylases or pullulanase. The use of SCA makes it possible to obtain especially advantageous slowly digestible starch products, and in particular to tangibly accelerate the formation of advantageous networks, thereby making the process easier and more cost effective. In addition, thermal stability is increased. The SCA here works to induce crystallinity in the basic starch on the one hand by forming mixed crystallites, and increase network density on the other, thereby reducing the swelling capacity, and hence the hydrolysis rate. To realize these advantages, as molecularly disperse a mixture of basic starch with the SCA is critical. This is achieved by mixing the SCA, e.g., in the form of a solution, with the at least partially gelatinized basic starch, or by adding the SCA in an amorphous state, e.g., in spray-dried form, or by adding the SCA in partially crystalline form, and then solubilizing it during preparation of the basic starch, or by directly obtaining the SCA during preparation of the basic starch by using debranched enzymes directly from the basic starch. Similar advantages are obtained when treating the basic starch with additional amylases, such as alpha amylase. This reduces the molecular weight and improves crystallizability. In addition, networks can also be obtained during the use of SCA under conditions where no networks would arise without SCA, e.g., at low water contents and low temperatures, where the basic starch is present in an amorphous, quasi-frozen state. Advantageous percentages of SCA relative to the overall starch In % w/w range from 1-95, preferably 2-70, more preferably 3-60, and most preferably 4-50.

Process Conditions

In order to manufacture slowly digestible starch product, the basic starch is set to an at least partially gelatinized state or at least partially plasticized state in a first step. It is advantageous that the SCA be as molecularly dispersed in the basic starch in this state. This is achieved through known cooking and mixing processes. Preparation via extrusion is particularly advantageous.

The water content in % w/w during preparation ranges from 10-90, preferably 14-70, more preferably 16-60, and most preferably 18-50. The mass temperature in ° C. during preparation ranges from −10-250, preferably 20-220, more preferably 50-200. The lower the water content, the higher the temperatures during preparation.

Network formation is triggered by conditioning from the prepared state, wherein the starch is present at least partially in an amorphous state, thereby converting the starch into a slowly digestible form. The parameters for conditioning are here important in terms of enabling the formation of advantageous networks, and the extent of hydrolysis rate reduction. The essential parameters for conditioning include water content Wo, temperature Tk and time tk. These parameters depend on the recipe (type of basic starch, if necessary a percentage of SCA). It was found that roughly the following conditions generally apply with respect to the advantageous parameters:

The water content Wo in % w/w during conditioning ranges from 10-90, preferably 14-70, more preferably 16-60, and most preferably 18-50. Closer-meshed networks characterized by a low swelling capacity Q are obtained with decreasing water content, and are advantageous for reducing the hydrolysis rate. Further, low water contents are advantageous, because the end product most often has a water content <30%, so that less process water must be removed again.

The difference Tk-To in ° C. with temperature To as a reference ranges from 20-150, preferably 35-135, more preferably 50-120, and most preferably 70100 wherein the following relationship exists between To and Wo:

TABLE 1

| | | | | | | | | | | | | | | | | |
|---|---|---|---|---|---|---|---|---|---|---|---|---|---|---|---|---|
| Wo | % | 10 | 15 | 20 | 25 | 30 | 35 | 40 | 45 | 50 | 55 | 60 | 65 | 70 | 80 | 90 |
| To | ° C. | 98 | 55 | 23 | −3 | −24 | −41 | −55 | −67 | −78 | −87 | −95 | −102 | −108 | −119 | −128 |

Interpolated values for To apply to water contents Wo between the indicated values. If the lower limits of Tk lie at temperatures <<0° C. based on the advantageous temperature intervals, the lower limit for Tk is the temperature just over the freezing point of the starch-water mixture (approx. −10° C.). Higher temperatures Tk are advantageously used as the water content Wo decreases.

The conditioning time tw in h ranges from 0-24, preferably 0.1-12, more preferably 0.25-6, and most preferably 0.5-3. A conditioning time of Oh here means that no special conditioning is executed, and the starch product is dried immediately after preparation. However, conditioning can take place under advantageous condition even given rapid drying, which in particular can be sufficient when using SCA for obtaining a low hydrolysis rate Ho. Of course, conditioning times >24 h can be used, and the specified advantageous ranges relate to economically optimized processes, wherein the shortest possible processing times are advantageous.

When using SCA, use is advantageously made of the higher temperatures tk, the lower water contents Wo and the shorter times tk, while conditions are opposite when SCA is not used. The conditioning parameters Wo and Tk can also exhibit a progression over time, which is especially advantageous if conditioning is combined with a drying process, making it possible to simplify and economically optimize the process.

Selecting suitable conditioning parameters is important to produce major effects, i.e., pronounced reductions in hydrolysis rate Ho, in as short a time as possible. For example, when using SCA at a water content ranging from about 20-35%, conditioning at 50° C. for half an hour can yield the same reduction in hydrolysis rate Ho as obtained for recipes without SCA at a water content ranging from about 30-50% via conditioning at 25° C. for 24 h. High thermal stability is achieved at a high content of amylose and/or while conditioning at high temperatures.

Drying

If necessary, conditioning is followed by drying, wherein the water content in % w/w is reduced to <30, preferably <20, and most preferably <15. To this end, use can be made of known drying processes, e.g., those used for drying pastas or cereals. Drying advantageously takes place at temperatures in ° C. ranging from 0-300, preferably 20-250, and most preferably 40-200. Also advantageous is drying at drying rates in % w/w of water/h ranging from 0.1-500, preferably 1-100, more preferably 3-50, and most preferably 5-25. If a sufficient network has already been set via conditioning once drying is initiated, high drying rates are used, while the lower drying rates are used if at least part of the network is to be established while drying. It is particularly relevant to set the suitable drying rate all the way down to the water content where network formation is still possible. At lower water contents, even the highest drying rates can then be used.

Selecting the suitable drying parameters makes it possible to combine drying with conditioning, thereby eliminating the need for separate conditioning. This is advantageous in terms of the process on the one hand, while the network formation yielding the reduced digestion rate takes place much faster at higher temperatures than at low temperatures on the other, so that the process can be simplified and accelerated as well.

Further Processing

In order to obtain the starch product in the form of a food additive, so that the GI of the food can be reduced, the starch product is directly granulated or comminuted to a particle size in mm ranging from 0.001-5, preferably 0.011, and most preferably 0.05-0.5, for which use can be made of various known comminuting methods, e.g., milling. However, comminuting or pre-comminuting can also take place before conditioning and/or drying, e.g., via die-face pelletizing after extrusion.

Comminuting can be substituted by molding before or after conditioning, using a mold suitable for consumption as a separate food, e.g., in the form of cereals or snacks. To this end, the corresponding raw materials are used for manufacturing the slowly digestible starch product, e.g., corn or wheat meal, sugar, salt, malt, and for manufacturing flakes or potato granulate and potato flakes, and for manufacturing potato snacks.

Additives

Various typical food additives can also be added to the slowly digestible starch product, such as fragrances and dyes, emulsifiers, proteins, low-calorie sweeteners and slowly digestible sweeteners and carbohydrates like xylitol, sorbitol, glycerin, erythritol, polydextrose isomalt, maltitol, lactitol, lactose, trehalose, fructose, fiber, in particular soluble fibers like beta-glucan. This percentage of soluble fibers enables a further synergistic reduction in the hydrolysis rate, since the high viscosity of soluble fibers additionally hampers the entrance and mobility of hydrolyzing enzymes.

Properties

The initial in vitro hydrolysis rate Ho is directly correlated with the GI, but can be determined much more easily and precisely, so that this variable is here used for characterizing the digestive behavior. Reference is made to Am J Clin Nutr 2002; 76:5-56 (International table of glycemic index and glycemic load values: 2002, p. 6: Why do GI values for the same types of food sometimes vary) with respect to the problem of GI values obtained from in vivo tests.

The slowly digestible starch product has an initial hydrolysis rate Ho in %/h of <300%/h, preferably <200, even more preferably <150, and most preferably <100. The value of 300%/h here corresponds to a GI value of roughly 50 (glucose standard). Of course, while higher values for Ho can also be set, the corresponding starch products are of little interest for GI reduction. The value of 220%/h corresponds to the initial hydrolysis rate of rye whole meal bread or pumpernickel (GI=approx. 43), white baguettes have a much higher value at an Ho=1000%/h (GI=approx. 95), while whole grain bread lies between the baguette and pumpernickel at an Ho=530%/h (GI=approx. 55-60). With respect to very slowly digestible starch of the kind also used in diabetes patients, native corn starch has previously served as the standard at an Ho=64%/h. However, even slower hydrolysis rates are desired, and this can be achieved with the starch product according to the invention, wherein values for Ho of down to 15%/h are obtained.

It is advantageous if as high a percentage of the starch product be obtained in slowly digestible form, i.e., hydrolyzed at a hydrolysis rate of <300%/h. The portion in % w/w of the slowly digestible starch product that is slowly digested (SD, slowly digestible) lies at >20, preferably >30, more preferably >45, and most preferably >60.

If necessary, the starch product has a constant or nearly constant hydrolysis rate Hc over a time tc in h of >0.25, preferably >0.5, more preferably >0.75, and most preferably >1. The constant hydrolysis rate phase can take place at the onset of hydrolysis and/or in a phase following the onset of hydrolysis. It is advantageous for the constant hydrolysis rate Hc in %/h to measure <300, preferably <200, more preferably <150, and most preferably <100. A constant hydrolysis rate corresponds to a glucose release that remains constant over time, and this is optimal in terms of keeping the blood sugar level constant at a desired level. Native cornstarch with an Ho=64%/h and tc=0.6 h (in vitro values) makes it possible to regulate the blood sugar level for roughly 4 h (in vivo). By contrast, the starch product according to the invention enables a blood sugar level regulation phase that is many times longer at roughly 24 h (in vivo), e.g., at Ho=16%/h and tc=3.5 h (in vitro). In particular, this can prevent undersugar in diabetic patients at night, for which the native cornstarch is inadequate.

The swelling capacity Q in water at room temperature for the starch product ranges from 1.1-4, preferably 1.15-3, more preferably 1.17-2.5 and most preferably 1.2-2. Hydrolysis is delayed as swelling capacity decreases, since the entry of amylases is increasingly hampered.

In addition to the lower hydrolysis rate relative to native cornstarch, another advantage to the starch product is its higher temperature stability. This enables a processing, e.g., admixing, of the slowly digestible starch product as an ingredient to a food at process temperatures typical for the food. In an advantageous embodiment, the DSC melting point Tp in ° C. for the crystallites of the slowly digestible starch product at a 70% water content measures >70, preferably >80, more preferably >90, and most preferably >100. At lower water contents, the DSC melting points are even significantly higher, e.g., in excess of 240° C. at 10% water content, thereby also enabling toasting with expansion or baking, wherein the starch product can be obtained as a separate food in the form of a tasty snack, for example. Temperature stability is also important when using the starch product as an ingredient, wherein the ingredient is subjected to various thermal processing steps.

Another advantage to the starch product is that the percentage of resistant starch can be set. If the starch product is used as an ingredient, this not only reduces the hydrolysis rate and GI, but also produces a share of resistant starch, eliminating the need to separately add fibers or resistant starch. In this case, a high resistant percentage of the starch product is advantageous, e.g., 20-30%. If the starch product is used as a food per se, a lower resistant percentage is preferred, e.g., 5-20%. The share of resistant starch in the slowly digestible starch in % w/w ranges from 0-50, preferably 3-45, and most preferably 5-40.

Applications

Roughly 0.1-1.0 g, preferably 0.25-0.5 g per kg of body weight of the slowly digestible starch product as a whole at Ho=70%/h (in vitro) is sufficient to ensure a sufficient (in vivo) continuous supply of glucose to the organism for a period of about 3-4 hours. This reflects a typical time in between meals. Correspondingly larger quantities (at an appropriately reduced Ho) are to be used for a longer continuous supply of glucose, e.g., for preventing undersugar overnight in diabetics or children, and in particular small children, who can wake up as the result of undersugar.

The starch product can be used in the form of a powder as an ingredient in a wide range of foods, as a result of which the hydrolysis rate or GI of the combination can be advantageously reduced, and in particular a long-lasting, constant release of glucose can be achieved, thereby preventing both undersugar and oversugar. The list includes, but is not limited to, cereals, Muesslis, snacks, French fries, chips, pasta, pizza, sauces, soups, crémes, fillings, syrups, puddings, milk products, yogurt, beverages, baked goods, cookies, bread, cakes, confectionery, puddings, children and baby food, diabetic nutrition, energy bars.

In addition, the starch product can also be consumed in the form of a tablet, making it possible to make more extensive use of the advantages to the slowly digestible starch product in a compressed form. This makes sense, for example, when there is no time to eat a meal.

Another consumable form would be as a food consisting primarily of slowly digestible starch product, e.g., cereals, cookies or snacks. In addition to the advantages already mentioned above relative to native cornstarch, this is an important advantage, since the consumption of native starches in the form of slurry or tablets is unpleasant. It clearly enhances the quality of life for diabetics if the blood sugar level can be regulated overnight by consuming, for example, a delicious snack.

### EXAMPLES

### Examples 1

These examples illustrate the reduction in the initial hydrolysis rate and setting of a constant hydrolysis rate for various recipes, as well as the influence of conditioning parameters. Starch was processed in a Brabender kneader with a 50 ml kneading chamber with water added at speeds ranging from 80-120 RPM to form a thermoplastic compound. The kneading chamber was thermostated to 90° C. In most cases, the starch was used in pregelatinized form, since this enabled a reduction in preparation time. Comparative tests with native starch required a longer processing time, but yielded comparable results with otherwise identical parameters. In mixtures with SCA, the SCA (short-chain, mostly crystalline amylose with an average polymerization level of 24) was mixed with water at a ratio of 1:2, and converted into a low-viscous solution at 160° C. in autoclaves over a period of 5 min. This solution was then supplied at a temperature of roughly 90° C. to the at least partially thermoplastic compound of the basic starch, which had a mass temperature of 95-100° C. After a mixing time of about 3 min, a homogenous mixture could be obtained. This mixture was pressed into a 0.5 mm thick film at temperatures of roughly 100° C., and then cooled within 10 min to room temperature. The water content Wo of this film was determined (approx. 300 mg samples, drying for 24 h at 85° C. over phosphorus pentoxide), and various samples were cut out and used again for various conditioning processes. The sample pieces for these conditioning processes were wrapped in saran film to keep the water content Wo constant.

The results for various recipes and heat treatments are presented on Table 1. The table contains the relevant hydrolysis parameters for reference samples of native cornstarch, amylase-treated cornstarch according to WO 2004/066955 A2 (wherein slowly digestible starch according to US 2003/0219520 A1 and US 2003/0215562 A1 is comparable thereto), resistant starch (Novelose 330, national starch), white bread (migros), whole grain bread (migros) and rye whole meal bread (pumpernickel, migros).

FIG. 1 shows several results for cornstarch. Also shown are the reference curves for native cornstarch, amylase-treated starch and Novelose 330. The WS 46-1 curve corresponds practically completely to amorphous starch, which is digested extraordinarily fast. All other WS curves have an initial hydrolysis rate Ho of below 200%/h up to 43%/h. Also distinctly visible is a linear progression of the curves that continues for a good 2.5 h (in vitro) at WS 49-2, wherein this period of time is many times greater in vivo. In general, Ho can be reduced to a particularly great degree by adding short-chain amylose (SCA), and even a massive reduction can be achieved without specific heat treatment. With respect to heat treatment, it was found that heat treatment for 1 h at 50° C. with an existing water content of roughly 30% yields practically the same result as heat treatment for 24 h at 25° C. It can be shown relative to native cornstarch that both a similar hydrolysis progression can be set, as well as a distinctly slowed hydrolysis progression. The resistant starch Novelose 330 exhibits a very rapid hydrolysis at the very beginning; a first portion, roughly half of the digestible share, is digested practically at the same rate as white bread relative to the digestible percentage of Novelose 330. The second half is then digested very slowly, too slowly to release a sufficient quantity of glucose over the longer term. Therefore, Novelose 330 and other resistant starches are not suitable for the slow release of glucose. The slowly digestible starch products according to WO 2004/066955 A2, US 2003/0219520 A1 and US 2003/0215562 A1 have basically similar characteristics to Novelose 330, with there being a percentage of comparatively quickly digestible starch and a relatively highly resistant percentage, but also a percentage of slowly digestible starch (compare curve for amylase-treated cornstarch). This characteristic is obviously less suitable than native cornstarch with respect to a controlled release of glucose.

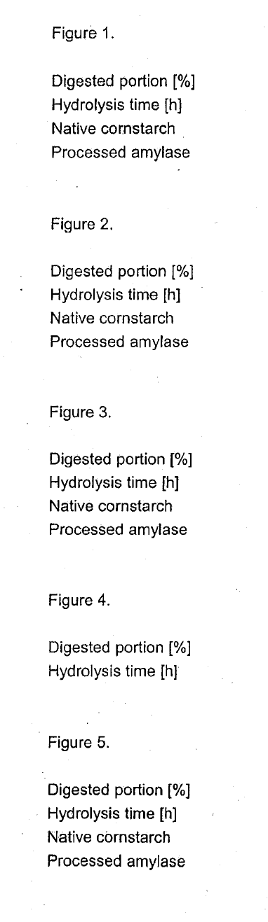

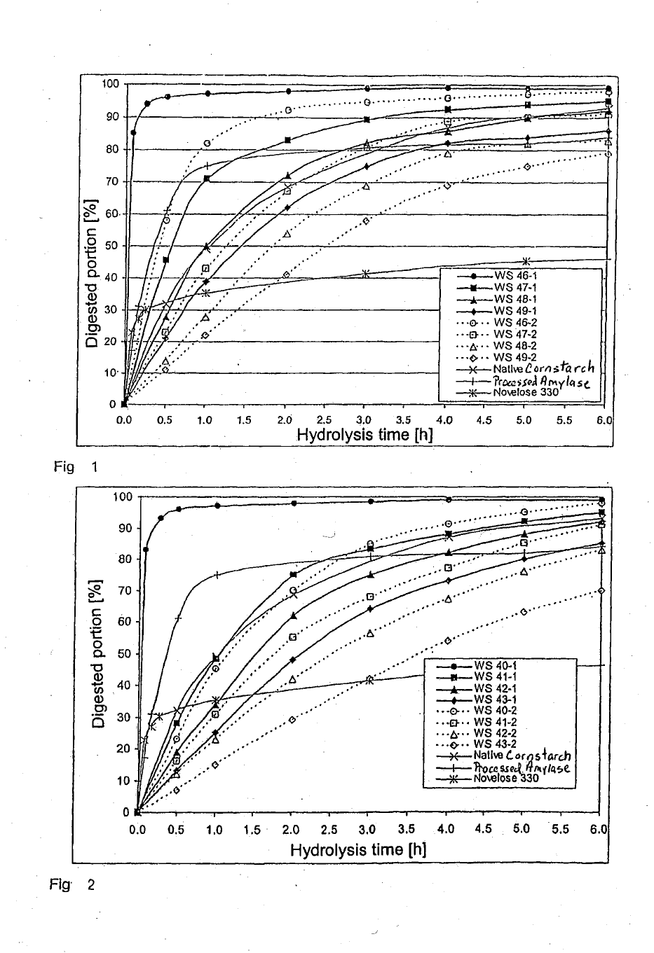

The WS curves on FIG. 2 were obtained with starch products based on potato starch, wherein the conditions are very similar in comparison to FIG. 1, the difference being that even somewhat lower hydrolysis rates and in part even longer linear areas were obtained.

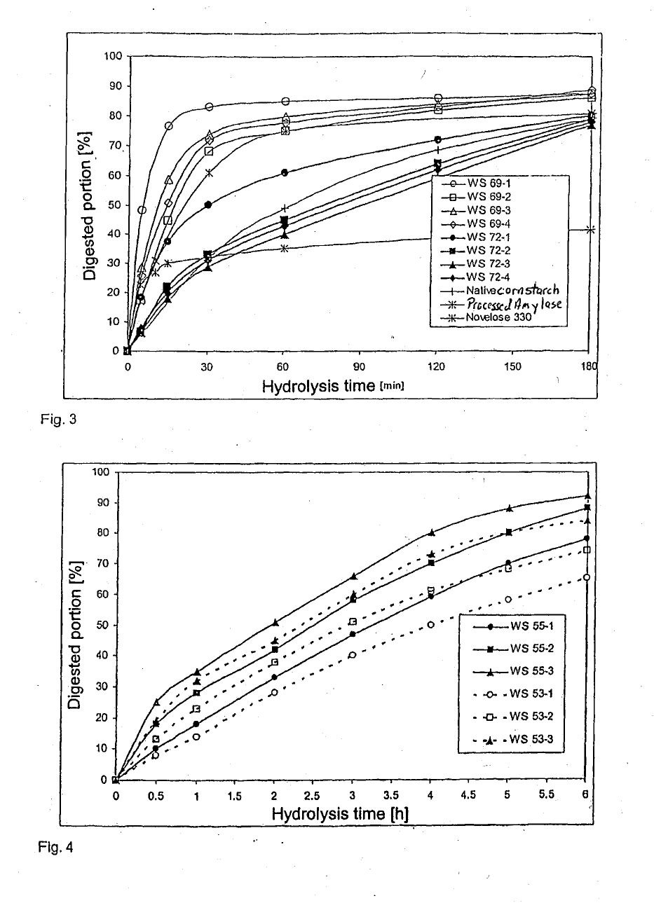

The WS curves on FIG. 3 were obtained with starch products based on pea starch with roughly 50% amylose. At the water content of 29%, the astounding effect when using short-chain amylose (SCA) becomes evident. While an Ho of 200%/h was obtained at WS 69-2 without SCA after one day of storage at 25° C., an initial hydrolysis rate Ho of 20%/h can be achieved using only 5% SCA and conditioning for 1 h at 70%. While such values are also possible without SCA, clearly longer conditioning processes at water contents exceeding 29% are required to this end.

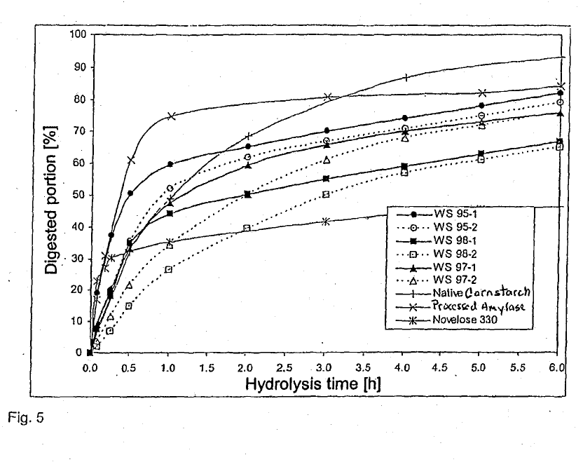

FIG. 4 shows the influence of particle size for slowly digestible starch products based on pea starch with 50% amylose content, and for potato starch.

Finally, FIG. 5 also depicts the results for slowly digestible starch product based on cornstarch with 70% amylose content. Advantageous hydrolysis characteristics can be achieved based on this starch as well. At WS 95 and WS 97, the starch had gelatinized to 75% and only minimally plasticized, while gelatinizing was complete and more plasticizing took place at WS 98.

### Example 2

This example illustrates the use of the starch product as an ingredient. A reference recipe with 70% wheat flour, 7% butter, 15% isomalt, 5% fructose, 1% salt, 0.8% calcium phosphate, 0.4% malt and 0.8% baking powder relative to dry mass was kneaded into dough at a water content of 28%, and cookies were molded from this. The cookies were baked for 12 min at 210° C. The hydrolysis rate Ho in relation to the starch percentage was determined to be 900%/h. In the reference recipe, a portion of the wheat flour was replaced by a powder according to WS 42-2, so that the recipe contained 45% wheat flour and 25% WS 42-2. The hydrolysis rate Ho relative to the starch percentage was determined to be 600%/h. Therefore, the GI could be reduced in relation to the starch percentage from roughly 88 to 68, or from the high GI range to the medium GI range.

### Example 3

This example illustrates the use of the starch product as a food per se, in particular as a potato snack. The same procedure is followed as in Example 1, wherein potato granules and potato flakes in a ratio of 8:2 were used as the basic starch, 1.4% salt was added, the share of SCA relative to the starch as a whole was 20%, and Wo measured 29%. The homogenous mixture was pressed into 0.5 mm thick films, and these films were packed in saran foil and stored at 60° C. for 1 h at a constant Wo. The films Were then cut into 1 cm×1 cm pieces and dried at 75° C. to a water content of 10%. At this water content, the pieces were toasted for 1 min in a forced air oven at 220° C. The hydrolysis measurement yielded an Ho of 27%/h (corresponding roughly to a G1 value of approx. 15-20), and this value remained constant for roughly 2 h. Therefore, the product has a distinctly slowed release of glucose by comparison to native cornstarch (Ho=64%/h), and is suitable for sustained glucose supply, in particular for diabetics. The organoleptic test resulted in a high crispiness and pleasant flavor. This makes the product suitable as a snack to replace organoleptically unattractive native cornstarch with additionally improved hydrolysis properties.

### Example 4

This example illustrates the use of the starch product as a food per se, in particular as a corn snack. The same procedure is followed as in Example 3, and corn flour was used as the basic starch. 0.4% malt and 7% isomalt (a low GI sugar) were also added in addition to the 1.4% salt. The share of SCA also measured 20%. The initial hydrolysis rate Ho of the toasted corn snack was about 34%, and remained constant for roughly 1.9 h. A high crispiness was determined here as well, and the taste strongly resembled that of Corn Flakes. Therefore, this product is suitable for use as a snack with a slow and constant glucose release, as with the product in Example 3.

### Example 5

This example illustrates the use of the starch product per se, in particular as a confectionary or fruit substitute. The process is the same as in Example 1, wherein tapioca starch and thin boiling cornstarch was used as the basic starch in a ratio of 7:3, and the share of SCA measured 20%. In addition, 10% xylitol and 30% glycerin were added, along with 1.5% citric acid and about 0.1% fruit flavoring. The water content Wo measured about 25%. The homogenized compound was pressed into a 3 mm thick film, and stored for 3 h at 40° C. (when using softeners like glycerin, the percentage of softener divided by 3 is regarded as an additional water content for determining the optimal temperature Tk for network formation, meaning that this water content here measured roughly 25+30/3=35%). The film conditioned in this way was cut into 3 mm×3 mm×3 mm pieces, each having a soft consistency, and resembling dried fruit pieces. These pieces were analyzed for hydrolysis rate, wherein an initial hydrolysis rate Ho of 37%/h was obtained, and remained constant for 2.5 h. Therefore, such products are also suitable for controlled glucose release. They can be consumed per se, or be added to various foods, like Muesslis or bars.

Measuring Methods

Hydrolysis measurements: The hydrolysis measurements were performed based upon the AOAC method 2002.02 using the resistant starch assay kit from Megazyme. Alpha amylase and amyloglucosidase are here used for hydrolysis. This method and the Megazyme kit were developed for the standardized determination of the percentage of resistant starch (RS) in starch-based products. By contrast, the hydrolysis was here stopped after specific intervals, e.g., after 0.5, 1, 2, 3 h, to obtain the share of digested starch at that point in time. The standard was correspondingly hydrolyzed for 16 h to determine the RS percentage. A glass tube with substrate is used per respective hydrolysis time. It was shown that this approach is more precise by comparison to the aliquot sampling. After hydrolysis was stopped, the residue, i.e., the undigested starch, was precipitated via centrifugation at 3000 g, dried and weighed (M1). The difference relative to the dry originally weighed-in quantity (M0) was used to obtain the share of digested starch (M1−M0)/M0. The results obtained in this way were identical with those from the determination of undigested starch via GOPOD (glucose oxidase-peroxidase-aminoantipyrin), as comparative tests showed. In the case of substrates that have other constituents in addition to starch and water, the soluble portion of non-starch constituents can be determined via reference tests without using amylases, and the non-soluble portion can be obtained from the difference of the RS share and M1 after 16 h. Therefore, hydrolysis of the starch fraction can be separated from the other processes.

The described method for in vitro analysis of the hydrolyzing kinetics can be correlated with known GI values. In the process, a good correlation was found to exist between the initial hydrolysis rate Ho and the corresponding GI values. This can be expected, since the majority of starch in most instances is digested at a rate of Ho. The GI value resulting for a specific Ho from the figure must be regarded as an approximate value, since GI values measured in vivo most often exhibit a broad scatter. By contrast, hydrolysis rates can be determined much more easily and precisely in vitro, so that these values will be used as the basis in this application.

DSC measurements: The differential scanning calorimetry (DSC) measurements were performed with a Perkin-Elmer DSC-7. The device was calibrated with indium. Closed stainless steel bars were used for the samples. The sample weight measured a respective 60 mg, the water content in the samples measured 70%, and the heating rate was 10° C./min. The respective peak temperature Tp of the melt endotherms of the crystalline portion of the starch samples was determined.

Swelling: The samples of slowly digestible starch were swelled by means of 0.5 mm thick, 1 cm×1 cm plates. In the process, the plates were dried to a water content of 10% (weight G0), and then stored in deionized water for 24 h at room temperature (weight G1). The swelling level was obtained as the weight of the swelled sample divided by the weight of the dry sample (0% water) as Q=G1/(0.9*G0).

| | | SCA | Wo | | d | | Ho | Hc | tc | SD | Tp | RS |
|---|---|---|---|---|---|---|---|---|---|---|---|---|
| No | Starch | [%] | [%] | Cond. | [mm] | Q | [%/h] | [%/h] | [h] | [%] | [° C.] | [%] |
| WS 46-1 | Corn | 0 | 30 | None | 0.5 | >10 | 1000 | 1000 | 0.08 | 0 | * | 1 |
| WS 47-1 | Corn | 10 | 30 | None | 0.5 | 2.6 | 90 | 90 | 0.6 | 97 | 98 | 3 |
| WS 48-1 | Corn | 20 | 30 | None | 0.5 | 2.2 | 55 | 55 | 0.7 | 94 | 105 | 6 |
| WS 49-1 | Corn | 30 | 30 | None | 0.5 | 1.9 | 43 | 43 | 0.7 | 93 | 114 | 7 |
| WS 46-2 | Corn | 0 | 30 | 1 h at 50° C. | 0.5 | 2.6 | 125 | 125 | 0.5 | 96 | 77 | 4 |
| WS 47-2 | Corn | 10 | 30 | 1 h at 50° C. | 0.5 | 1.9 | 47 | 47 | 0.9 | 95 | 103 | 5 |
| WS 48-2 | Corn | 20 | 30 | 1 h at 50° C. | 0.5 | 1.4 | 28 | 28 | 1.7 | 93 | 111 | 7 |
| WS 49-2 | Corn | 30 | 30 | 1 h at 50° C. | 0.5 | 1.3 | 22 | 22 | 2.5 | 92 | 117 | 8 |
| WS 40-1 | Potato | 0 | 30 | None | 0.5 | >10 | 1000 | 1000 | 0.08 | 0 | * | 1 |
| WS 41-1 | Potato | 10 | 30 | None | 0.5 | 2.5 | 58 | 58 | 0.6 | 96 | 94 | 4 |
| WS 42-1 | Potato | 20 | 30 | None | 0.5 | 1.7 | 33 | 33 | 1.7 | 95 | 104 | 5 |
| WS 43-1 | Potato | 30 | 30 | None | 0.5 | 1.4 | 25 | 25 | 2.2 | 93 | 116 | 7 |
| WS 40-2 | Potato | 0 | 30 | 1 h at 50° C. | 0.5 | 1.8 | 48 | 48 | 0.8 | 96 | 75 | 4 |
| WS 41-2 | Potato | 10 | 30 | 1 h at 50° C. | 0.5 | 1.7 | 30 | 30 | 1.4 | 95 | 101 | 5 |
| WS 42-2 | Potato | 20 | 30 | 1 h at 50° C. | 0.5 | 1.4 | 23 | 23 | 2 | 93 | 110 | 7 |
| WS 43-2 | Potato | 30 | 30 | 1 h at 50° C. | 0.5 | 1.3 | 15 | 15 | 3.5 | 92 | 116 | 8 |
| WS 55-1 | Potato | 20 | 36 | 1 h at 50° C. | 0.5 | 1.3 | 16 | 14 | 3.5 | 91 | 109 | 9 |
| WS 55-2 | Potato | 20 | 36 | 1 h at 50° C. | 0.35 | 1.7 | 36 | 15 | 3 | 91 | 109 | 9 |
| WS 55-3 | Potato | 20 | 36 | 1 h at 50° C. | 0.2 | 1.9 | 54 | 16 | 3 | 93 | 109 | 7 |
| WS 55-1 | HA pea | 20 | 25 | 1 h at 50° C. | 0.5 | 1.2 | 14 | 12 | 4 | 83 | 114 | 17 |
| WS 55-2 | HA pea | 20 | 25 | 1 h at 50° C. | 0.35 | 1.3 | 26 | 13 | 2.5 | 84 | 114 | 16 |
| WS 55-3 | HA pea | 20 | 25 | 1 h at 50° C. | 0.2 | 1.5 | 38 | 14 | 3 | 86 | 114 | 14 |
| WS 69-1 | HA pea | 0 | 29 | None | 0.3 | 6 | 600 | 600 | 0.08 | 10 | 72 | 9 |
| WS 69-2 | HA pea | 0 | 29 | 1 d at 25° C. | 0.3 | 3.1 | 200 | 200 | 0.3 | 89 | 77 | 11 |
| WS 69-3 | HA pea | 0 | 29 | 1 h at 70° C. | 0.3 | 5 | 360 | 360 | 0.2 | 30 | 85 | 12 |
| WS 69-4 | HA pea | 0 | 29 | 1 h at 90° C. | 0.3 | 4.5 | 330 | 330 | 0.2 | 35 | 105 | 12 |
| WS 72-1 | HA pea | 5 | 29 | None | 0.3 | 2.9 | 200 | 12 | 2 | 90 | 98 | 10 |
| WS 72-2 | HA pea | 5 | 29 | 1 d at 25° C. | 0.3 | 2.3 | 90 | 20 | 2.5 | 89 | 100 | 11 |
| WS 72-3 | HA pea | 5 | 29 | 1 h at 70° C. | 0.3 | 2.2 | 80 | 20 | 2.5 | 89 | 104 | 11 |
| WS 72-4 | HA pea | 5 | 29 | 1 h at 90° C. | 0.3 | 2 | 70 | 22 | 2.5 | 89 | 111 | 11 |
| WS 95-1 | HA corn | 0 | 24 | None | 0.15 | 1.8 | 200 | | | 89 | 110 | 11 |
| WS 95-2 | HA corn | 0 | 24 | 1 h at 70° C. | 0.15 | 1.5 | 70 | | | 87 | 118 | 13 |
| WS 97-1 | HA corn | 10 | 35 | None | 0.15 | 1.5 | 68 | | | 86 | 118 | 14 |
| WS 97-2 | HA corn | 10 | 35 | 1 h at 50° C. | 0.15 | 1.4 | 46 | | | 85 | 121 | 15 |
| WS 98-1 | HA corn | 0 | 37 | None | 0.15 | 1.5 | 70 | | | 84 | 115 | 16 |
| WS 98-2 | HA corn | 0 | 37 | 1 h at 40° C. | 0.15 | 1.3 | 32 | | | 82 | 118 | 18 |

| | | | | | | |
|---|---|---|---|---|---|---|
| Native cornstarch | 64 | 64 | 0.6 | 97 | 72 | 3 |
| Amylase-treated cornstarch | 200 | 200 | 0.25 | 85 | 92 | 11 |
| Novelese 330 | 270 | 270 | 5 | 20 | 131 | 52 |
| White baguette | 1000 | | | 0 | * | 1 |
| Whole grain bread | 530 | | | 10 | * | 9 |
| Rye whole meal bread | 220 | | | 75 | * | 17 |

TABLE 1

| | | | |
|---|---|---|---|
| HA pea | High-amylose content pea | Ho | Initial hydrolysis rate |
| HA corn | starch | Hc | Constant hydrolysis rate |
| SCA | High-amylose content | Tc | Constant hydrolysis time |
| Wo | cornstarch | SD | Slowly digestible starch |
| Cond. | Short chain amylose, DP-24 | Tp | DSC melting point |
| d | Water content during | RS | Percentage of resistant |
| Q | cond./before drying | * | starch/fiber |
| | Conditioning | | No crystallites |
| | Particle size | | |
| | Swelling level | | |

It should be understood that various changes and modifications to the presently preferred embodiments described herein will be apparent to those skilled in the art. Such changes and modifications can be made without departing from the spirit and scope of the present invention and without diminishing its intended advantages. It is therefore intended that such changes and modifications be covered by the appended claims.

1. A slowly digestible starch product comprising a swellable starch network, wherein the linking points of the swellable network are formed by crystallites, wherein the starch product is made from at least one starch having an amylose content of >20%, wherein the starch product has, relative to the starch product, 2-70% w/w short-chain amylose with a polymerization level <100, and wherein the starch product has an initial hydrolysis rate (“Ho”)<300%/h and has a constant or nearly constant hydrolysis rate (“Hc”)<300%/h for at least 0.50 h.

2. The starch product of claim 1, wherein the starch product has 3-60% w/w short-chain amylose relative to the starch product.

3. The starch product of claim 1, wherein the starch product has a constant or nearly constant hydrolysis rate (“Hc”)<300%/h for at least 0.75 h.

4. The starch product of claim 3, wherein the starch product has a constant or nearly constant hydrolysis rate (“Hc”)<300%/h for at least 1 h.

5. The starch product of claim 1, wherein a portion of the starch product measuring >20% is hydrolyzed at a constant or nearly constant hydrolysis rate (“Hc”).

6. The starch product of claim 1, wherein the swelling capacity Q of the starch product in water at room temperature ranges from 1.1 to 4.

7. The starch product of claim 1, wherein the DSC melting point (“Tp”) of the crystallites measures >70° C.

8. The starch product of claim 1, wherein the starch product has a percentage of resistant starch ranging from 0-50%.

9. The starch product of claim 1, wherein the starch product has at least one additive.

10. The starch product of claim 9, wherein the starch product has a percentage of soluble fibers.

11. The starch product of claim 1, wherein the starch product is added to a food as an ingredient.

12. The starch product of claim 11, wherein the starch product is added to a bar as an ingredient.

13. The starch product of claim 1, wherein the starch product is present as a cereal or snack.

14. The starch product of claim 1, wherein the starch product is a tablet.

15. A method for manufacturing a slowly digestible starch product, the method comprising:
at least partially gelatinizing or at least partially plasticizing at least one starch having an amylose content of >20%,
obtaining a mixture of the at least partially gelatinized or at least partially plasticized starch with a short-chain amylose in a molecularly dispersed state via extrusion, and
conditioning the starch mixture prepared in this way, during which a starch network is set, to provide a resultant starch product having an initial hydrolysis rate (Ho)<300%/h and a constant or nearly constant hydrolysis rate (“Hc”)<300%/h for at least 0.50 h.

16. The method of claim 15, wherein the short-chain amylose has a polymerization level of <100 and is present in an amount of 2-70% w/w relative to the starch product.

17. The method of claim 15, wherein the water content (“Wo”) during the conditioning ranges from 10 to 90% w/w.

18. The method of claim 15, wherein the water content (“Wo”) during the conditioning ranges from 14 to 70% w/w.
